(19) United States
(12) Patent Application Publication
(10) Pub. No.: US 2004/0003006 A1
(43) Pub. Date: Jan. 1, 2004

(54) Layout pattern verification device for verifying a layout pattern of transistors in the manufacturing of a large scale integrated circuit

(76) Inventors: Kazuhiro Kanazawa, Hyogo (JP); Yoshihiro Ito, Hyogo (JP); Toshihiko Kataoka, Hyogo (JP); Yukiharu Mikawa, Hyogo (JP)

Correspondence Address: BURNS, DOANE, SWECKER & MATHIS, L.L.P., P.O. Box 1404, Alexandria, VA, 22313-1404, US

(21) Appl. No.: 10/323,887

(22) Filed: Dec. 20, 2002

(30) Foreign Application Priority Data
Jul. 1, 2002 (JP) 2002-192513

(51) Int. Cl. G06F 12/00

(52) U.S. Cl. 707/200

(57) ABSTRACT

A ROM bit map file indicating placement areas of transistors of a mask ROM is prepared from a layout condition of the transistors in the mask ROM and physical positions of the transistors described in a layout pattern file, a logic simulation is performed by using the ROM bit map file and connection information of the transistors, and the physical positions of the transistors are verified according to a simulation result. Therefore, even though there are a large number of transistors in the mask ROM, the physical positions of the transistors can be reliably verified.

### BACKGROUND OF THE INVENTION

1. Field of the Invention

The present invention relates to a layout pattern verification device in which a layout pattern file necessary for the manufacturing of a large scale integrated circuit (LSI) having a mask read-only memory (hereinafter, called mask ROM) is verified.

2. Description of Related Art

FIG. 11 is a view showing the configuration of a conventional layout pattern verification device. In FIG. 11, 1 indicates a ROM structure file in which a transistor layout condition (for example, a transistor mapping rule and co-ordinates of each transistor) applied to transistors of a mask ROM is described and stored. 2 indicates a ROM structure file reading unit for reading out the transistor layout condition described in the ROM structure file 1. 3 indicates a ROM code file in which program codes (hereinafter called ROM codes) of transistors to be placed in the mask ROM are described and stored. 4 indicates a ROM code file reading unit for reading out the ROM codes stored in the ROM code file 3.

5 indicates a layout pattern file preparing unit for specifying a placement area of each transistor in the mask ROM according to the corresponding ROM code read in the ROM code file reading unit 4, calculating a physical position (or co-ordinates) of each specified placement area while referring to the transistor layout condition read in the ROM structure file reading unit 2 and preparing a layout pattern file 6 from the physical positions of the transistors to be placed in the mask ROM. In the layout pattern file 6, the placement areas of the transistors placed at the physical positions of the mask ROM are described. 7 indicates an image displaying unit for producing an image indicating a positional relation of the placement areas of the transistors in the mask ROM according to the layout pattern file 6 and visually displaying the image.

FIG. 12 is a circuit diagram showing a logical circuit of the mask ROM. In FIG. 12, 11 indicates an X-address decoder connected with a plurality of address signal lines A0 to A3 and a plurality of column signal lines X0 to X7 serially disposed in a column direction. One of the column signal lines X0 to X7 is selected in the X-address decoder 11 according to a series of four address bit values of the address signal lines A0 to A3. 12 indicates a Y-address decoder connected with a plurality of address signal lines A4 to A7 and a plurality of row signal lines Y0 to Y7 serially disposed in a row direction. One of the row signal lines Y0 to Y7 is selected in the Y-address decoder 12 according to a series of four address bit values of the address signal lines A4 to A7.

Each column signal line intersects the row signal lines Y0 to Y7 to form a plurality of intersections, and a placement area 10 indicated by a square figure is placed around each intersection. Therefore, each placement area 10 is specified by a row number corresponding to one row signal line and a column number corresponding to one column signal line. A transistor can be placed in each placement area 10. In the manufacturing of the mask ROM, transistors are not necessarily placed at all placement areas 10, a part of placement areas 10 are selected according to the ROM codes, and transistors are placed at the selected placement areas 10 respectively.

FIG. 13 is an explanatory view showing a positional relation among physical positions of transistors placed in the mask ROM. In FIG. 13, 14 indicates a series of address bit values of the address signal lines A0 to A3. 15 indicates a series of address bit values of the address signal lines A4 to A7. 16 indicates a width of each placement area 10 occupied by one transistor 13. 17 indicates a height of the placement area 10 of one transistor 13. 18 indicates a pitch of the placement areas 10 in the column direction. 19 indicates a pitch of the placement areas 10 in the row direction. 20 indicates a reference position (hereinafter, called an offset position) of the placement areas 10 used as a reference for the placement of the transistors 13.

FIG. 14 is an explanatory view showing contents described in the ROM structure file 1. In FIG. 14, 21 indicates an X co-ordinate of the offset position 20. 22 indicates a Y co-ordinate of the offset position 20. 23 indicates the width of each placement area 10. 24 indicates the height of each placement area 10. 25 indicates the pitch of the placement areas 10 in the column direction. 26 indicates the pitch of the placement areas 10 in the row direction. 27 indicates a bit name of address bits in the column direction. 28 indicates a series of bit values of the address bits in the column direction. 29 indicates a bit name of address bits in the row direction. 30 indicates a series of bit values of the address bits in the row direction.

FIG. 15 is an explanatory view showing contents described in the ROM code file 3. In FIG. 15, 31 indicates an address designating one placement area 10 of a transistor. 32 indicates a ROM code. In this example, when the ROM code 32 is equal to “1”, the ROM code 32 indicates that one transistor 13 is placed at the placement area 10 designated by the address 31. In contrast, when the ROM code 32 is equal to “0”, the ROM code 32 indicates that no transistor is placed at the placement area 10 designated by the address 31.

FIG. 16 is an explanatory view visually showing contents described in the layout pattern file 6. FIG. 17 is a flow chart showing the processing of the conventional layout pattern verification device.

Next, an operation of the conventional layout pattern verification device will be described below.

A transistor layout condition is read out from the ROM structure file 1 to the ROM structure file reading unit 2 (step ST1 of FIG. 17). As shown in FIG. 14, the transistor layout condition includes the X co-ordinate and Y co-ordinate of the offset position, the width and height of each placement area 10, the pitch of the placement areas 10 in the column direction, the pitch of the placement areas 10 in the row direction, the bit name and a series of bit values of address bits in the column direction, and the bit name and a series of bit values of address bits in the row direction.

Thereafter, the address indicating one placement area 10 and the ROM code corresponding to the address are read out from the ROM code file 3 to the ROM code file reading unit 4 (step ST2 of FIG. 17). For example, as shown in FIG. 15, one address 31 and one ROM code 32 listed in a pair are read out to the ROM code file reading unit 4 for each placement area 10.

Thereafter, in the layout pattern file preparing unit 5, it is checked whether or not the ROM code 32 read out by the ROM code file reading unit 4 is equal to “1”. In cases where the ROM code 32 read out by the ROM code file reading unit 4 is equal to “1”, the placement area 10 designated by the address 31 corresponding to the ROM code 32 is specified by the ROM code file reading unit 4, and the placement of one transistor 13 at the specified placement area 10 is set. For example, in cases where the address 31 is expressed by “0010” in the hexadecimal notation, the placement area 10 indicated by a mesh area in FIG. 13 is specified to place one transistor 13 at this placement area 10. Thereafter, in the layout pattern file preparing unit 5, co-ordinates (X co-ordinate and Y co-ordinate) of the specified placement area 10 are calculated with reference to the transistor layout condition read out by the ROM structure file reading unit 2, and a physical position of the specified placement area is obtained (step ST3 of FIG. 17).

In contrast, in cases where the ROM code 32 read out by the ROM code file reading unit 4 is equal to “0”, it is not required to place one transistor 13 at the placement area 10 of the mask ROM designated by the address 31. Therefore, no placement area of one transistor 13 is specified, and the calculation of co-ordinates is not performed in the layout pattern file preparing unit 5.

Thereafter, the placement of the transistor 13 at one placement area 10 placed at the calculated co-ordinates is described in a layout pattern file 6, and the layout pattern file 6 is prepared (step ST4 of FIG. 17).

Thereafter, it is judged whether or not all ROM codes corresponding to all placement areas 10 of the mask ROM are read out from the ROM code file 3 to the ROM code file reading unit 4 (step ST5 of FIG. 17). In cases where all ROM codes are not read out from the ROM code file 3, the procedure in the steps ST2 to ST4 is again performed, and the layout pattern file 6 is renewed. When all ROM codes are read out from the ROM code file 3, the preparation of the layout pattern file 6 is completed in the layout pattern file preparing unit 5. Thereafter, in the image displaying unit 7, an image of the placement areas respectively placed at the calculated co-ordinates of the transistor 13 is produced as a layout pattern of the placement areas according to the layout pattern file 6, and a layout pattern of the placement areas 10 of the transistors 13 is visually displayed (step ST6 of FIG. 17).

Therefore, an operator can confirm with his or her own eyes whether or not the layout pattern file 6 describing a layout pattern of the placement areas of the transistors 13 actually placed is appropriately prepared, and the operator can verify the contents described in the ROM code file 3.

Because the conventional layout pattern verification device has the above-described configuration, in cases where the number of transistors placed in the mask ROM is small, the operator can verify the placement areas 10 of the transistors actually placed. However, the number of transistors placed in the mask ROM is actually very large. For example, there are thousands or ten thousands transistors in the mask ROM. Therefore, it is almost impossible to verify the placement areas 10 actually placing a large number of transistors with the operator's own eyes, and a problem has arisen that LSI having a defective mask ROM is produced.

### SUMMARY OF THE INVENTION

An object of the present invention is to provide, with due consideration to the drawbacks of the conventional layout pattern verification device, a layout pattern verification device in which positions of all logic elements placed in a mask read only memory are reliably verified even though a large number of logic elements are placed in the mask read only memory.

The object is achieved by the provision of a layout pattern verification device including ROM bit map file preparing means and verifying means. The ROM bit map file preparing means prepares a ROM bit map file indicating placement areas of logic elements from physical positions of the logic elements in a mask read only memory. The verifying means verifies the physical positions of the logic elements according to the placement areas of the logic elements and connection information of the logic elements.

Accordingly, even though a large number of logic elements are placed in the mask read only memory, the physical positions of all logic elements in the mask read only memory can be reliably verified.

The object is also achieved by the provision of a layout pattern verification device including ROM net list file preparing means, verifying ROM net list file preparing means and verifying means. The ROM net list file preparing means prepares a ROM net list file indicating a connection relation among the logic elements from physical positions of the logic elements. The verifying ROM net list file preparing means prepares a verifying ROM net list file indicating a connection relation among the logic elements from placement areas of the logic elements. The verifying means verifying the physical positions of the logic elements by comparing the ROM net list file and the verifying ROM net list file.

Accordingly, even though a large number of logic elements are placed in the mask read only memory, the physical positions of all logic elements in the mask read only memory can be reliably verified.

The object is also achieved by the provision of a layout pattern verification device including ROM bit map file preparing means, verifying ROM bit map file preparing means and verifying means. The ROM bit map file preparing means prepares a ROM bit map file indicating placement areas of logic elements from physical positions of the logic elements in a mask read only memory. The verifying ROM bit map file preparing means prepares a verifying bit map file indicating placement areas of the logic elements from program codes of the logic elements. The verifying means compares the ROM bit map file and the verifying bit map file and verifies the physical positions of the logic elements.

Accordingly, even though a large number of logic elements are placed in the mask read only memory, the physical positions of all logic elements in the mask read only memory can be reliably verified.

### BRIEF DESCRIPTION OF THE DRAWINGS

FIG. 1 is a view showing the configuration of a layout pattern verification device according to a first embodiment of the present invention;

FIG. 2 is a flow chart showing the processing performed in a layout pattern verification device of the layout pattern verification device according to the first embodiment of the present invention;

FIG. 3 shows an example of a two-dimensional table;

FIG. 4 is a view showing the configuration of a layout pattern verification device according to a second embodiment of the present invention;

FIG. 5 is a flow chart showing the processing performed in the layout pattern verification device according to the second embodiment of the present invention;

FIG. 6 shows circuit diagram data;

FIG. 7 shows an example of a verifying ROM net list file;

FIG. 8 is a view showing the configuration of a layout pattern verification device according to a third embodiment of the present invention;

FIG. 9 is a flow chart showing the processing performed in the layout pattern verification device according to the third embodiment of the present invention;

FIG. 10 is a view showing the configuration of a layout pattern verification device according to a fourth embodiment of the present invention;

FIG. 11 is a view showing the configuration of a conventional layout pattern verification device;

FIG. 12 is a circuit diagram showing a logical circuit of a mask ROM;

FIG. 13 is an explanatory view showing a positional relation among physical positions of transistors placed in the mask ROM shown in FIG. 12;

FIG. 14 is an explanatory view showing contents described in a ROM structure file of the conventional layout pattern verification device shown in FIG. 1;

FIG. 15 is an explanatory view showing contents described in a ROM code file of the conventional layout pattern verification device shown in FIG. 1;

FIG. 16 is an explanatory view visually showing contents described in a layout pattern file displayed by an image displaying unit of the conventional layout pattern verification device shown in FIG. 1; and

FIG. 17 is a flow chart showing the processing performed in the conventional layout pattern verification device.

### DETAILED DESCRIPTION OF THE PREFERRED EMBODIMENTS

Embodiments of the present invention will now be described with reference to the accompanying drawings.

Embodiment 1

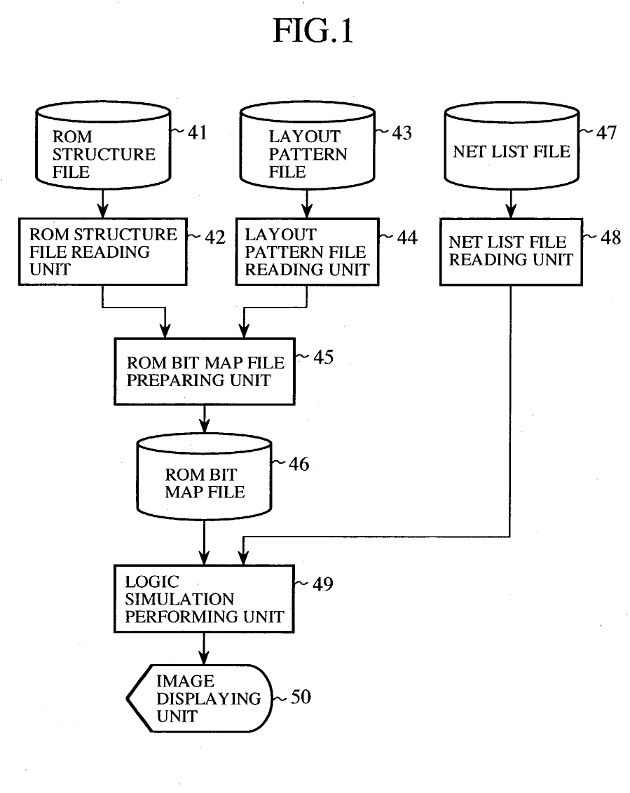

FIG. 1 is a view showing the configuration of a layout pattern verification device according to a first embodiment of the present invention.

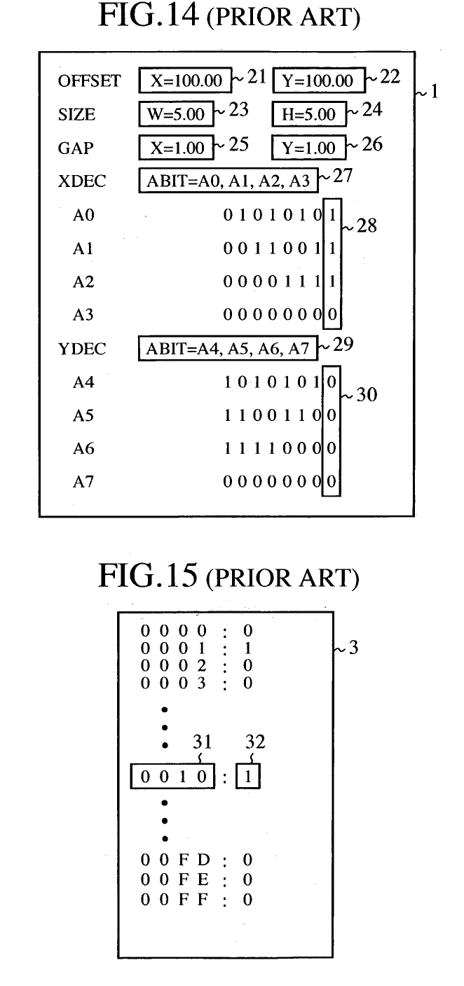

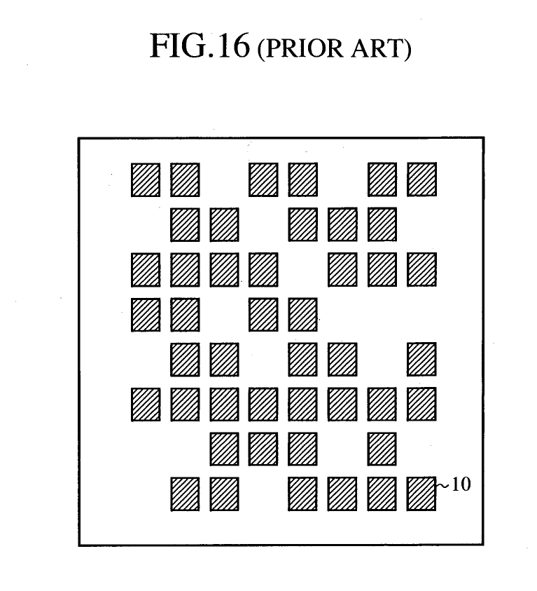

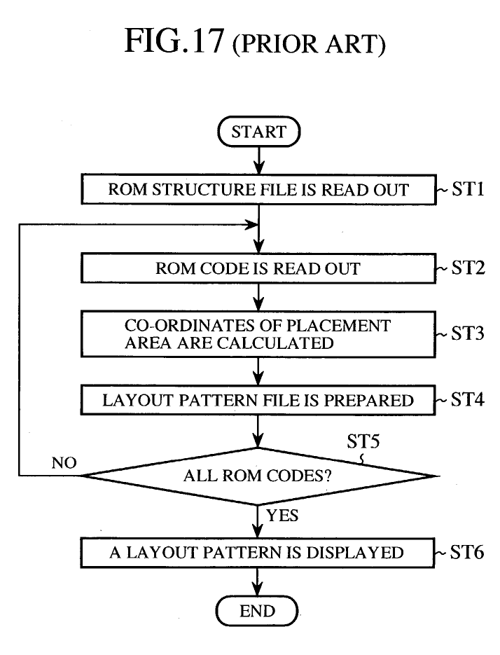

In FIG. 1, 41 indicates a ROM structure file in which a transistor layout condition (or a layout condition) applied to transistors (or logic elements) of a mask ROM (or mask read only memory) is described and stored. The contents of the transistor layout condition is, for example, shown in FIG. 14. 42 indicates a ROM structure file reading unit for reading out the transistor layout condition stored in the ROM structure file 41. 43 indicates a layout pattern file in which a physical position (which denotes co-ordinates indicating an X co-ordinate and a Y co-ordinate) of each transistor 13 to be placed in the mask ROM is described and stored. 44 indicates a layout pattern file reading unit for reading out the contents described in the layout pattern file 43.

45 indicates a ROM bit map file preparing unit for specifying both a row number and a column number of a placement area 10 occupied by each transistor 13, of which the physical position is described in the layout pattern file 43, with reference to the transistor layout condition read out to the ROM structure file reading unit 42 and the layout pattern read out to the layout pattern file reading unit 44 and preparing a ROM bit map file 46 indicating the placement areas 10 of the transistors 13 to be placed in the mask ROM.

47 indicates a net list file in which connection information indicating a connection relation among elements (for example, a central processing unit, a timer, address decoders and transistors) composing the mask ROM, information of a delay time in each element and information of a signal intensity in each element are described. 48 indicates a net list file reading unit for reading out the pieces of information such as the connection information described in the net list file 47.

49 indicates a logic simulation performing unit (or verifying means) for performing a logic simulation by using the placement areas 10 of the transistors 13 described in the ROM bit map file 46 and the information of the elements read out to the net list file reading unit 48 to verify the physical positions of the transistors 13 described in the layout pattern file 43. 50 indicates an image displaying unit for displaying a verification result obtained in the logic simulation performing unit 49.

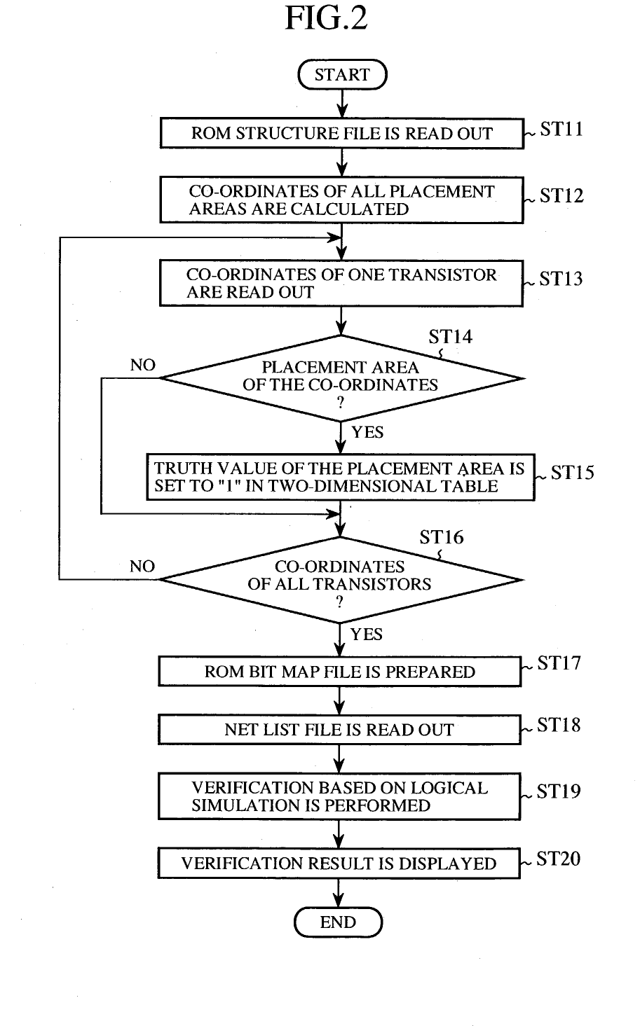

FIG. 2 is a flow chart showing the processing performed in the layout pattern verification device according to the first embodiment of the present invention.

Next, an operation of the layout pattern verification device will be described below.

In the ROM structure file reading unit 42, the transistor layout condition applied to transistors 13 to be placed in a mask ROM is read out from the ROM structure file 41 (step ST11). As shown in FIG. 14, the ROM structure file 41 includes both the X co-ordinate and Y co-ordinate of the offset position, the width and height of each placement area 10, the pitch of the placement areas 10 in the column direction, the pitch of the placement areas 10 in the row direction, the bit name and a series of bit values of address bits in the column direction, and the bit name and a series of bit values of address bits in the row direction.

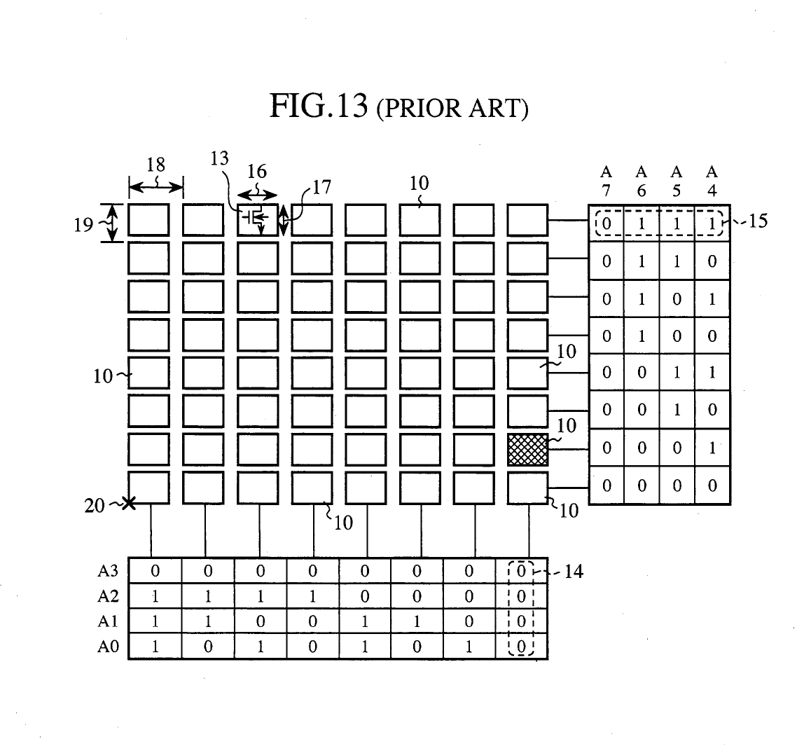

Thereafter, in the ROM bit map file preparing unit 45, co-ordinates of all placement areas 10 placed in the mask ROM are calculated with reference to the transistor layout condition (step ST12). In the example of the mask ROM shown in FIG. 13, because a maximum of sixty-four (8×8) transistors can be placed in the mask ROM, co-ordinates of the sixty-four placement areas 10 are calculated.

Thereafter, in the layout pattern file reading unit 44, co-ordinates indicating the physical position of one transistor 13 are read out from the layout pattern file 43 (step ST13).

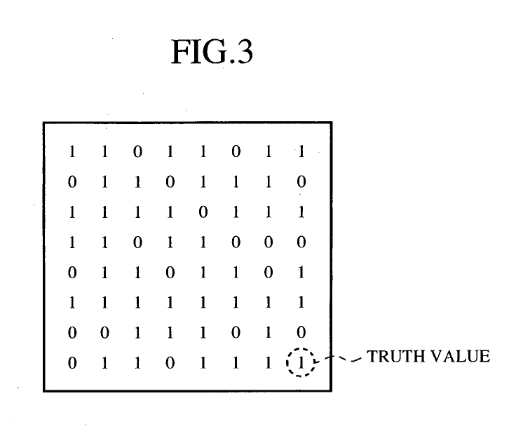

Thereafter, in the ROM bit map file preparing unit 45, each time the co-ordinates of the transistor 13 is read out to the layout pattern file reading unit 44, the co-ordinates of the transistor 13 read out from the layout pattern file 43 are compared with the co-ordinates of each of the placement areas 10 calculated in the step ST12, and it is checked whether or not co-ordinates of each placement area 10 calculated agrees with the co-ordinates of the transistor 13 (step ST14). In cases where the co-ordinates of the transistor 13 read out from the layout pattern file 43 agree with the co-ordinates of one placement area 10 calculated, the placement area 10 calculated is specified as the placement area 10 of the transistor 13. In this case, the placement area 10 calculated is specified by specifying both a row number and a column number of the placement area 10. Thereafter, a truth value corresponding to the specified placement area 10 is set to “1” in a two-dimensional table (step ST15). For example, in cases where the placement area 10 of a column number X7 and a row number Y0 is specified, as shown in FIG. 3, a truth value placed at the bottom right of the two-dimensional table is set to “1”. Here, the truth values of all placement areas 10 placed in the mask ROM are preset to “0” in the two-dimensional table.

Thereafter, the processing of the steps ST13 to ST15 is repeatedly performed until the to be placed in the mask ROM are read out from the layout pattern file 43 to the layout pattern file reading unit 44 in the step ST13 (step ST16). When the co-ordinates of all transistors 13 to be placed in the mask ROM are read out, the setting of the truth values in the two-dimensional table is completed. Therefore, as an example, the two-dimensional table shown in FIG. 3 is obtained.

Thereafter, the form of the two-dimensional table is changed to a file form to prepare a ROM bit map file 46 from the two-dimensional table (step ST17). Therefore, the placement areas 10 corresponding to the truth values of “1” are indicated in the ROM bit map file 46.

Thereafter, in the net list file reading unit 48, connection information indicating a connection relation among the transistors 13 placed in the mask ROM is read out from the net list file 47 (step ST18).

Thereafter, a logic simulation is performed in the logic simulation performing unit 49 by using the connection information of the transistors 13 and the placement areas 10 of the transistors 13 indicated by the ROM bit map file 46. In this logic simulation, a connection pattern of the transistors 13 placed in the placement areas 10 is, for example, simulated on condition that the transistors 13 of the placement areas 10 are used for the mask ROM of which a use purpose is predetermined, and a simulation result indicating the connection pattern of the transistors 13 is obtained. Thereafter, it is verified whether or not the simulation result agrees with an expected value (step ST19). In other words, it is verified whether or not the physical positions of the transistors 13 of the mask ROM described in the layout pattern file 43 are appropriately prepared, or it is verified whether or not a layout pattern of the placement areas 10 of the transistors 13 set according to the layout pattern file 43 is appropriately set. In this verification, as an example, the expected value indicates the connection relation among the transistors 13 of the placement areas 10 indicated by the ROM bit map file 46. In cases where the simulation result agrees with an expected value to a high degree, it is judged that the layout pattern file 43 is appropriately prepared while satisfying the connection relation among the transistors 13 described in the net list file 47. In other cases, it is judged that the layout pattern file 43 is not appropriately prepared.

Thereafter, in the image displaying unit 50, a verification result obtained in the logic simulation performing unit 49 is displayed (step ST20). For example, in cases where it is judged that the layout pattern file 43 is appropriately prepared, a message indicating the appropriate preparation of the layout pattern file 43 is displayed. Also, in cases where it is judged that the layout pattern file 43 is not appropriately prepared, a message indicating the inappropriate preparation of the layout pattern file 43 is displayed.

As is described above, in the first embodiment, the logic simulation performing unit 49 refers to the placement areas 10 of the transistors 13 prepared in the ROM bit map file preparing unit 45 and indicated by the ROM bit map file 46 and the connection information of the transistors 13 described in the net list file 47, and the logic simulation performing unit 49 automatically verifies whether or not the physical positions of the transistors 13 described in the layout pattern file 43 are appropriately set while satisfying the connection relation among the transistors 13. Therefore, though the operator verifies with his or her own eyes in the conventional layout pattern verification device whether or not the connection relation among the transistors 13 to be placed in the mask ROM is satisfied, the logic simulation performing unit 49 can automatically verify whether or not the connection relation among the transistors 13 to be placed in the mask ROM is satisfied. Accordingly, even though a large number of transistors 13 are placed in the mask ROM, the physical positions of the transistors 13 and the placement areas 10 of the transistors 13 can be reliably verified.

In this embodiment, the displacement area of each transistor representing the logic element is verified. However, it is applicable that the displacement area of each capacitor or resistor representing the logic element be verified.

Embodiment 2

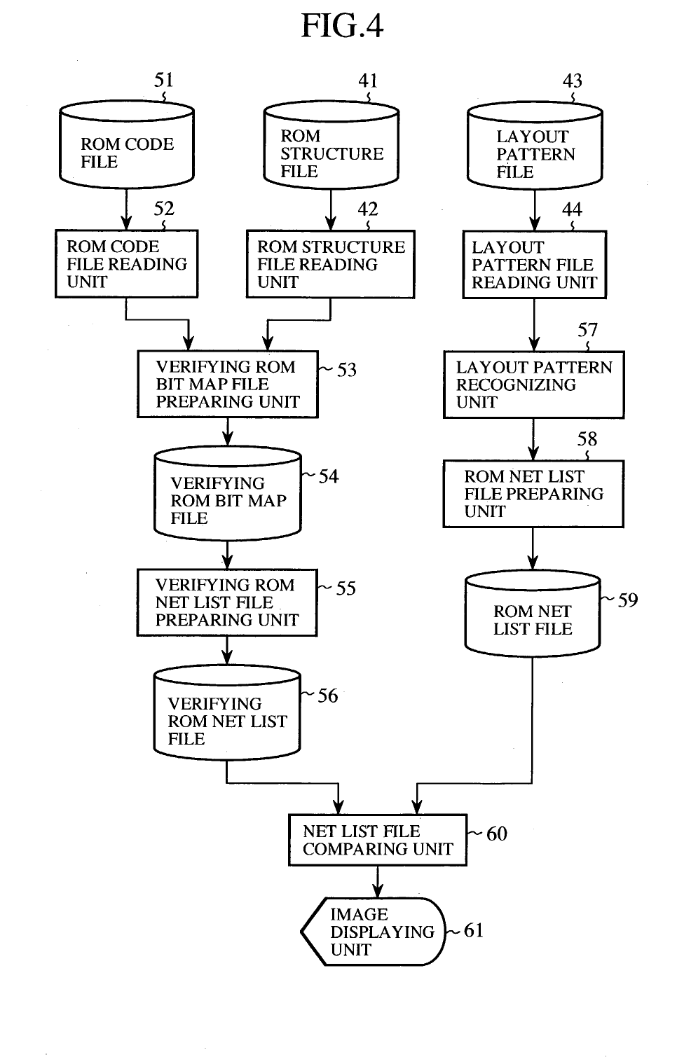

FIG. 4 is a view showing the configuration of a layout pattern verification device according to a second embodiment of the present invention. The constituent elements, which are the same as those shown in FIG. 1, are indicated by the same reference numerals as those of the constituent elements shown in FIG. 1, and additional description of those constituent elements is omitted.

In FIG. 4, 51 indicates a ROM code file (or a program code file) in which program codes (hereinafter, called ROM codes) corresponding to all placement areas 10 of a mask ROM are described. An example of the ROM codes is shown in FIG. 15. 52 indicates a ROM code file reading unit for reading out the ROM codes described in the ROM code file 51. 53 indicates a verifying ROM bit map file preparing unit for specifying both a row number and a column number of the placement area 10 of each transistor 13 to be placed in the mask ROM while referring to the ROM codes read out to the ROM code file reading unit 52 and the transistor layout condition read out to the ROM structure file reading unit 42 and preparing a verifying ROM bit map file 54 in which the specified placement areas 10 of transistors 13 to be placed in the mask ROM are described.

55 indicates a verifying ROM net list file preparing unit for producing circuit diagram data while referring to the specified placement areas 10 of the transistors 13 described in the verifying ROM bit map file 54 and preparing a verifying ROM net list file 56 indicating a connection relation among the transistors 13 from the circuit diagram data. Here, verifying ROM net list file preparing means comprises the verifying ROM bit map file preparing unit 53 and the verifying ROM net list file preparing unit 55.

57 indicates a layout pattern recognizing unit for recognizing a layout pattern of transistors and wires described in the layout pattern file 43. 58 indicates a ROM net list file preparing unit (or ROM net list file preparing means) for preparing a ROM net list file 59 describing a connection relation of the transistors from the layout pattern of the transistors and wires recognized in the layout pattern recognizing unit 57. Here, ROM net list file preparing means comprises the layout pattern recognizing unit 57 and the layout pattern recognizing unit 58.

60 indicates a net list file comparing unit (or verifying means) for comparing the verifying ROM net list file 56 and the ROM net list file 59 and verifying the physical positions of the transistors 13 described in the layout pattern file 43 according to a comparison result. 61 indicates an image displaying unit for displaying a verification result obtained in the net list file comparing unit 60.

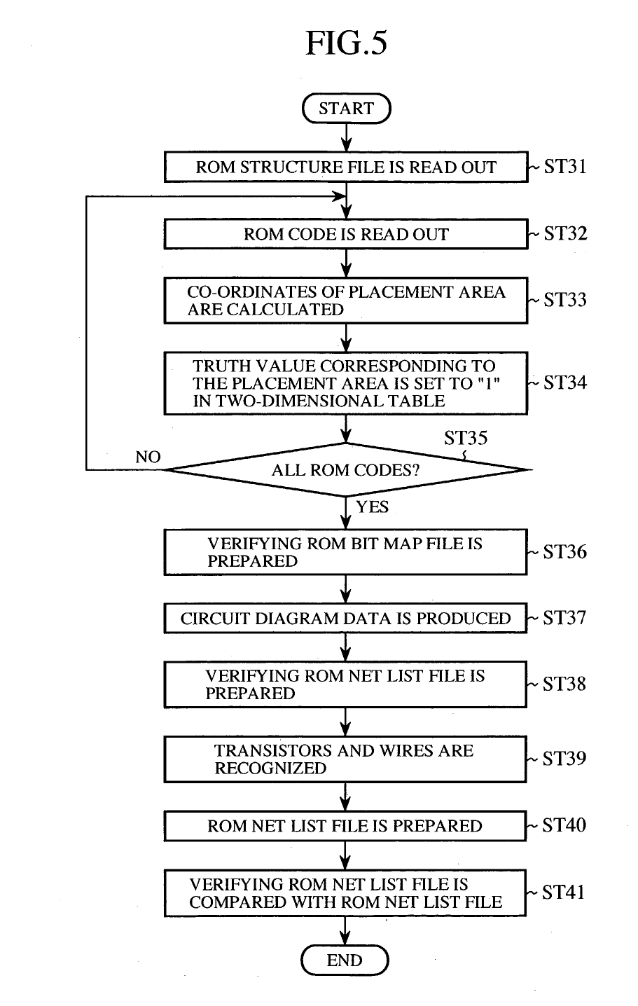

FIG. 5 is a flow chart showing the processing performed in the layout pattern verification device according to the second embodiment of the present invention.

Next, an operation of the layout pattern verification device will be described below with reference to FIG. 5.

A transistor layout condition is read out from the ROM structure file 41 to the ROM structure file reading unit 42 (step ST31). As shown in FIG. 14, the transistor layout condition includes the X co-ordinate and Y co-ordinate of the offset position 20, the width and height of the placement area 10, the pitch of the placement areas 10 in the column direction, the pitch of the placement areas 10 in the row direction, the bit name and a series of bit values of address bits in the column direction, and the bit name and a series of bit values of address bits in the row direction.

Thereafter, one address indicating one placement area 10 and the ROM code corresponding to the address are read out from the ROM code file 51 to the ROM code file reading unit 52 (step ST32). For example, as shown in FIG. 15, one address 31 and one ROM code 32 listed in a pair are read out to the ROM code file reading unit 52.

Thereafter, in the verifying ROM bit map file preparing unit 53, in cases where the ROM code 32 read out by the ROM code file reading unit 52 is equal to “1”, because one transistor 13 is placed at the placement area 10 corresponding to the ROM code, the placement area 10 is specified according to the address 31 read out by the ROM code file reading unit 52. In this case, both a row number and a column number of the placement area 10 are specified.

Thereafter, in the verifying ROM bit map file preparing unit 53, co-ordinates of the specified placement area 10 are calculated with reference to the transistor layout condition read out by the ROM structure file reading unit 42 (step ST33), and a truth value of a two-dimensional table corresponding to the specified placement area 10 is set to “1” (step ST34) to place one transistor 13 at the specified placement area 10.

In contrast, in cases where the ROM code 32 read out by the ROM code file reading unit 52 is equal to “0”, it is not required to place one transistor 13 at the placement area 10 of the mask ROM indicated by the address 31 read out with the ROM code 32. Therefore, no placement area 10 of the transistor 13 is specified, and the calculation of co-ordinates is not performed in the verifying ROM bit map file preparing unit 53.

Thereafter, it is judged whether or not all ROM codes are read out from the ROM code file 51 to the ROM code file reading unit 52 (step ST35). In cases where all ROM codes are not read out from the ROM code file 51, the procedure in the steps ST32 to ST34 is again performed, and the two-dimensional table is renewed. When the reading-out of all ROM codes from the ROM code file 51 is completed, the preparation of the two-dimensional table is completed in the verifying ROM bit map file preparing unit 53. Thereafter, in the verifying ROM bit map file preparing unit 53, a form of the two-dimensional table is changed to a file form to obtain a verifying ROM bit map file 54 (step ST36).

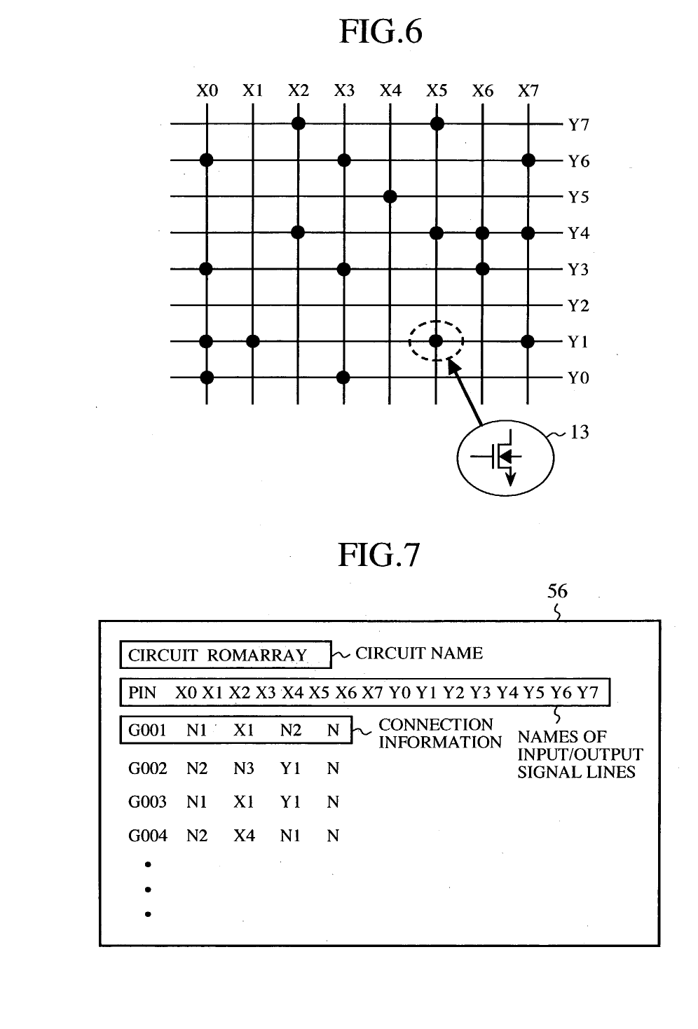

Thereafter, in the verifying ROM net list file preparing unit 55, it is checked whether or not the truth value of the verifying ROM bit map file 54 corresponding to each placement area 10 of the mask ROM is set to “1”. In cases where the truth value of the verifying ROM bit map file 54 corresponding to one placement area 10 is set to “1”, one intersection corresponding to the placement area 10 is selected from the intersections of the column signal lines X0 to X7 and the row signal lines Y0 to Y7, one transistor 13 is placed at the selected intersection. When a plurality of transistors 13 of the placement areas 10 corresponding to all truth values set to “1” are placed at intersections respectively, circuit diagram data shown in FIG. 6 is produced (step ST37). Here, in cases where the truth value of the verifying ROM bit map file 54 corresponding to one placement area 10 is set to “0”, no transistor is placed at an intersection corresponding to the placement area 10. In the circuit diagram data shown in FIG. 6, though the drawing of wires connecting the transistors 13 is omitted, the circuit diagram data actually indicates that the transistors 13 are connected with each other through wires. Also, because the transistors 13 of the intersections are placed so as to function as the mask ROM of which a use purpose is predetermined, a connection relation among the transistors 13 through wires is determined so as to produce the circuit diagram data from the transistors 13 placed at the intersections.

Thereafter, in the verifying ROM net list file preparing unit 55, a verifying ROM net list file 56 indicating a connection relation among the transistors 13 is prepared from the circuit diagram data (step ST38). An example of the verifying ROM net list file 56 is shown in FIG. 7.

Also, the physical positions of the transistors 13 of the mask ROM are described in the layout pattern file 43. When the contents of the layout pattern file 43 are read out to the layout pattern file reading unit 44, graphic form recognizing processing is performed for the layout pattern file 43 in the layout pattern recognizing unit 57. Therefore, the transistors 13 and wires connecting the transistors 13 in the mask ROM are recognized in the layout pattern recognizing unit 57 (step ST39).

Thereafter, in the ROM net list file preparing unit 58, a layout pattern of the transistors 13 and the wires recognized in the layout pattern recognizing unit 57 is referred, and a ROM net list file 59 describing a connection relation among the transistors 13 is prepared (step ST40). Here, the ROM net list file 59 is prepared in the same net list file form as that of the verifying ROM net list file 56.

Thereafter, in the net list file comparing unit 60, the connection relation among the transistors 13 described in the verifying ROM net list file 56 is compared with the connection relation among the transistors 13 described in the ROM net list file 59 (step ST41). In cases where the verifying ROM net list file 56 agrees with the ROM net list file 59, it is verified that the layout pattern file 43 is appropriately prepared. In contrast, in cases where the verifying ROM net list file 56 does not agree with the ROM net list file 59, it is verified that the layout pattern file 43 is not appropriately prepared.

Thereafter, in the image displaying unit 61, a verification result obtained in the net list file comparing unit 60 is displayed. For example, in cases where the verifying ROM net list file 56 agrees with the ROM net list file 59, a message indicating the appropriate preparation of the layout pattern file 43 is displayed. Also, in cases where the verifying ROM net list file 56 does not agree with the ROM net list file 59, a message indicating the inappropriate preparation of the layout pattern file 43 is displayed.

As is described above, in the second embodiment, the verifying ROM net list file 56 prepared in the verifying ROM net list file preparing unit 55 is compared with the ROM net list file 59 prepared in the ROM net list file preparing unit 58. Accordingly, even though a large number of transistors 13 are placed in the mask ROM, the physical positions of the transistors 13 described in the layout pattern file 43 can be reliably verified.

Embodiment 3

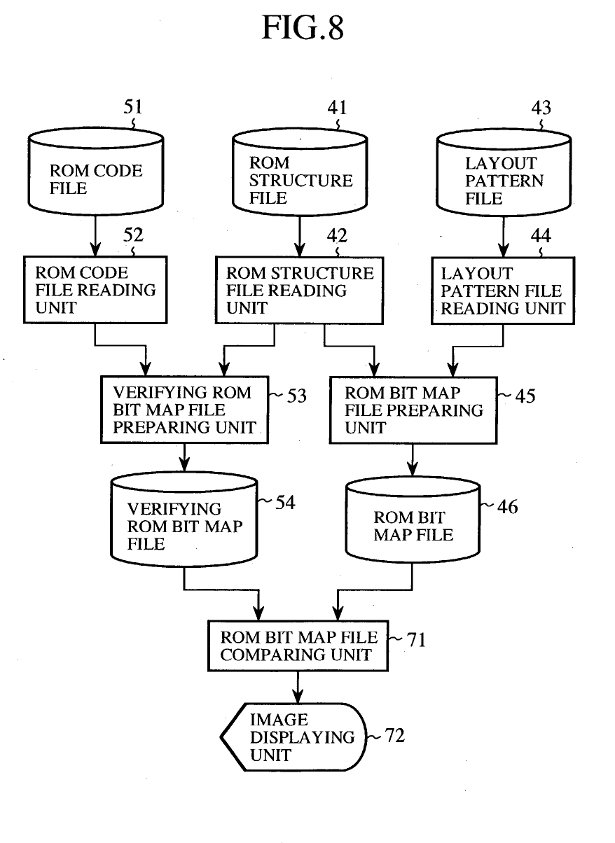

FIG. 8 is a view showing the configuration of a layout pattern verification device according to a third embodiment of the present invention. The constituent elements, which are the same as those shown in FIG. 1 or FIG. 4, are indicated by the same reference numerals as those of the constituent elements shown in FIG. 1 or FIG. 4, and additional description of those constituent elements is omitted.

In FIG. 8, 71 indicates a ROM bit map file comparing unit (or verifying means) for comparing the verifying ROM bit map file 54 prepared in the verifying ROM bit map file preparing unit 53 and the ROM bit map file 46 prepared in the ROM bit map file preparing unit 45 and verifying the physical positions of the transistors 13 described in the layout pattern file 43 according to an obtained comparison result. 72 indicates an image displaying unit for displaying a verification result obtained in the ROM bit map file comparing unit 71.

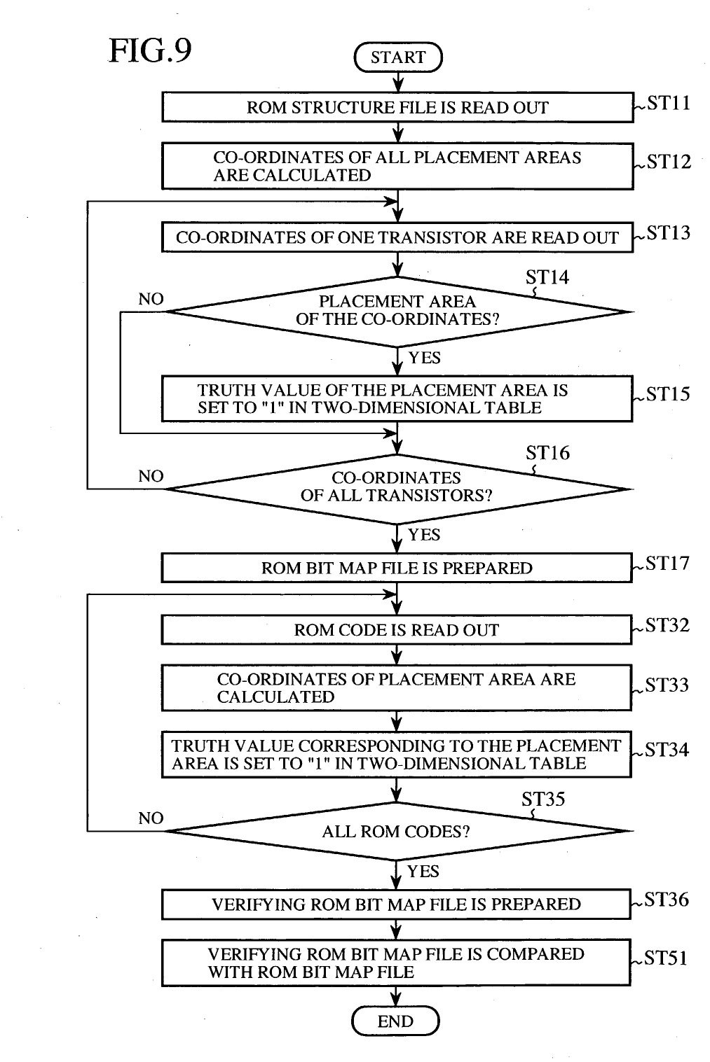

FIG. 9 is a flow chart showing the processing performed in the layout pattern verification device according to the third embodiment of the present invention.

Next, an operation of the layout pattern verification device will be described below.

In the same manner as in the first embodiment, the ROM bit map file 46 is prepared in the ROM bit map file preparing unit 45 (step ST17). Also, in the same manner as in the second embodiment, the verifying ROM bit map file 54 is prepared in the verifying ROM bit map file preparing unit 53 (ST36). Thereafter, in the ROM bit map file comparing unit 71, the verifying ROM bit map file 54 is compared with the ROM bit map file 46 (step ST51). In cases where the verifying ROM bit map file 54 agrees with the ROM bit map file 46, it is verified that the layout pattern file 43 is appropriately prepared. Also, in cases where the verifying ROM bit map file 54 does not agree with the ROM bit map file 46, it is verified that the layout pattern file 43 is not appropriately prepared. Here, the verifying ROM bit map file 54 is prepared in the same bit map file form as that of the ROM bit map file 46.

Thereafter, in the image displaying unit 72, a verification result obtained in the ROM bit map file comparing unit 71 is displayed. For example, in cases where the verifying ROM bit map file 54 agrees with the ROM bit map file 46, a message indicating the appropriate preparation of the layout pattern file 43 is displayed. Also, in cases where the verifying ROM bit map file 54 does not agree with the ROM bit map file 46, a message indicating the inappropriate preparation of the layout pattern file 43 is displayed.

As is described above, in the third embodiment, the verifying ROM bit map file 54 prepared in the verifying ROM bit map file preparing unit 53 is compared with the ROM bit map file 46 prepared in the ROM bit map file preparing unit 45. Accordingly, even though a large number of transistors 13 are placed in the mask ROM, the physical positions of the transistors 13 described in the layout patter file 43 can be reliably verified.

Embodiment 4

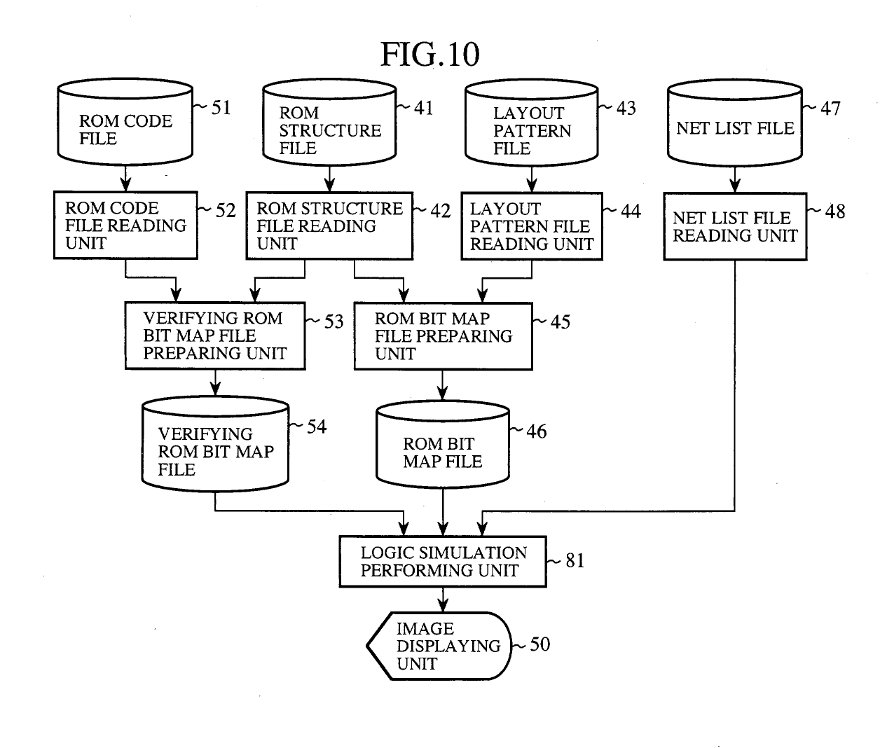

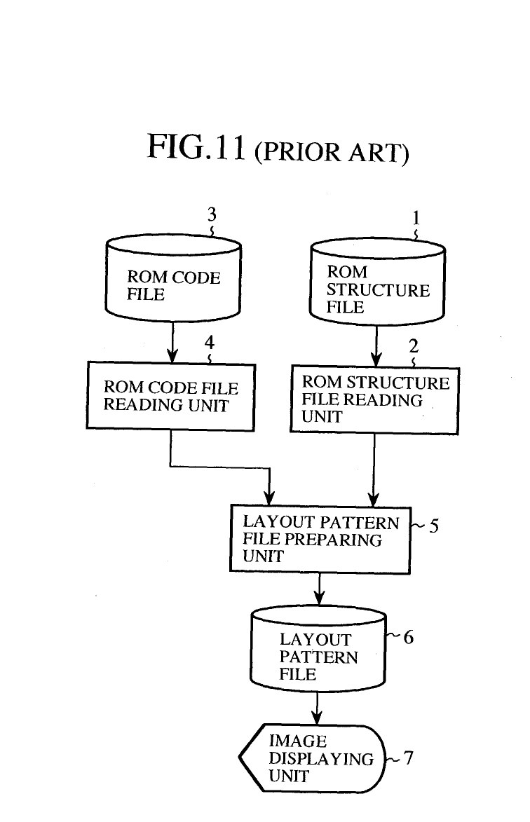

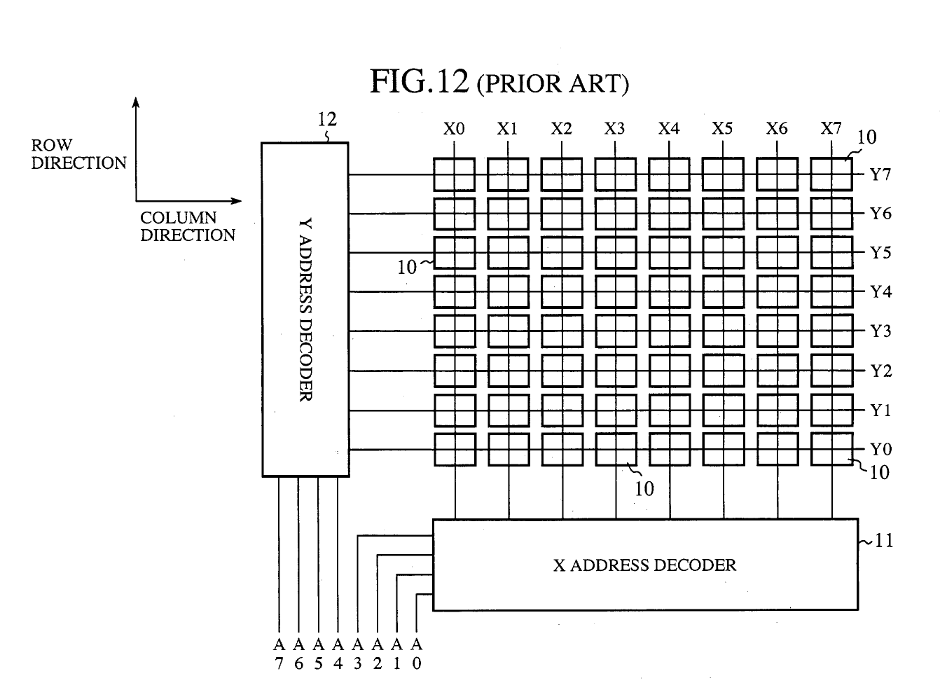

FIG. 10 is a view showing the configuration of a layout pattern verification device according to a fourth embodiment of the present invention. The constituent elements, which are the same as those shown in FIG. 1 or FIG. 4, are indicated by the same reference numerals as those of the constituent elements shown in FIG. 1 or FIG. 4, and additional description of those constituent elements is omitted.

In FIG. 10, 81 indicates a logic simulation performing unit (or verifying means) for verifying the physical positions of the transistors 13 described in the layout pattern file 43 in the same manner as in the logic simulation performing unit 49, and verifying the transistor layout condition applied to transistors of the mask ROM and described in the ROM structure file 41 while referring to the placement areas 10 of the transistors 13 described in the verifying ROM bit map file 54 and the connection information of transistors described in the net list file 47.

In the first embodiment, the physical positions of the transistors 13 are verified in the logic simulation performing unit 49. In contrast, in the fourth embodiment, in addition to the verification of the physical positions of the transistors 13, the transistor layout condition (refer to FIG. 14) applied to transistors of the mask ROM is verified.

In detail, in the logic simulation performing unit 81, a logic simulation is performed by using the placement areas 10 of the transistors 13 described in the verifying ROM bit map file 54 and the connection information of the transistors 13 described in the net list file 47. In this logic simulation, because the transistors 13 is placed in the mask ROM to perform a logic operation of the mask ROM predetermined, a connection relation among the transistors 13 can be simulated from the placement areas 10 of the transistors 13 to obtain a simulation result, and the connection relation among the transistors 13 simulated from the placement areas 10 of the transistors 13 is compared with the connection information of the transistors 13 described in the net list file 47. Thereafter, it is verified whether or not the simulation result agrees with an expected value. In other words, it is verified whether or not the transistor layout condition of the ROM structure file 41 is appropriately described in the ROM structure file 41. The expected value denotes the connection information of the transistors 13 described in the net list file 47. In cases where the simulation result agrees with the expected value to a high degree, it is judged that the transistor layout condition is appropriately described. In other cases, it is judged that the transistor layout condition is not appropriately described.

Thereafter, in the image displaying unit 50, a verification result obtained in the logic simulation performing unit 81 is displayed. For example, in cases where the transistor layout condition is appropriately described in the ROM structure file 41, a message indicating the appropriate description of the transistor layout condition is displayed. Also, in cases where the transistor layout condition is not appropriately described in the ROM structure file 41, a message indicating the inappropriate description of the transistor layout condition is displayed.

As is described above, in the fourth embodiment, the transistor layout condition applied to transistors of the mask ROM is verified while referring to the placement areas 10 of the transistors 13 described in the verifying ROM bit map file 54 and the connection information of the transistors 13 described in the net list file 47. Accordingly, it can be checked whether or not the transistor layout condition is appropriately described in the ROM structure file 41.

What is claimed is:

1. A layout pattern verification device comprising:
a ROM structure file for describing a layout condition of a plurality of logic elements in a mask read only memory;
a layout pattern file for describing physical positions of the logic elements in the mask read only memory;
ROM bit map file preparing means for specifying a plurality of placement areas of the logic elements according to the layout condition of the logic elements described in the ROM structure file and the physical positions of the logic elements described in the layout pattern file and preparing a ROM bit map file indicating the placement areas of the logic elements;
a net list file for describing connection information indicating a connection relation among the logic elements; and
verifying means for verifying the physical positions of the logic elements described in the layout pattern file according to the placement areas of the logic elements in the ROM bit map file prepared by the ROM bit map file preparing means and the connection information of the logic elements described in the net list file.

2. The layout pattern verification device according to claim 1, wherein a logic simulation is performed by the verifying means by using the placement areas of the logic elements described in the ROM bit map file and the connection information of the logic elements described in the net list file, and the verifying means verifies whether or not an obtained simulation result agrees with an expected value.

3. The layout pattern verification device according to claim 1, further comprising:
a program code file for describing a plurality of program codes respectively indicating whether or not one logic element is placed at the corresponding placement area; and
verifying ROM bit map file preparing means for preparing a verifying ROM bit map file indicating the placement areas of the logic elements from the program codes described in the program code file and the layout condition of the logic elements, wherein the verifying means verifies the layout condition of the logic elements according to the placement areas of the logic elements indicated in the verifying ROM bit map file and the connection information of the logic elements described in the net list file.

4. The layout pattern verification device according to claim 3, wherein a logic simulation is performed by the verifying means by using the placement areas of the logic elements indicated in the verifying ROM bit map file and the connection information of the logic elements described in the net list file, and the verifying means verifies whether or not an obtained simulation result agrees with an expected value.

5. The layout pattern verification device according to claim 1, wherein each logic element is formed of a transistor.

6. A layout pattern verification device comprising:
a layout pattern file for describing physical positions of a plurality of logic elements in a mask read only memory;
ROM net list file preparing means for recognizing a layout pattern of the logic elements and a plurality of wires connecting the logic elements according to the physical positions of the logic elements described in the layout pattern file and preparing a ROM net list file indicating a connection relation among the logic elements from the recognized layout pattern;
a program code file for describing a plurality of program codes respectively indicating whether or not one logic element is placed at a placement area of the mask read only memory;
a ROM structure file for describing a layout condition of the logic elements in the mask read only memory;
verifying ROM net list file preparing means for specifying a plurality of placement areas of the logic elements of the mask read only memory corresponding to the program codes described in the program code file according to the layout condition of the logic elements described in the ROM structure file and preparing a verifying ROM net list file indicating a connection relation among the logic elements from the specified placement areas of the logic elements; and
verifying means for comparing the ROM net list file prepared by the ROM net list file preparing means and the verifying ROM net list file prepared by the verifying ROM net list file preparing means and verifying the physical positions of the logic elements described in the layout pattern file according to an obtained comparison result.

7. The layout pattern verification device according to claim 6, wherein the verifying ROM net list file preparing means produces circuit diagram data according to the placement areas of the logic elements corresponding to the program codes and prepares the verifying ROM net list file indicating the connection relation among the logic elements from the circuit diagram data.

8. A layout pattern verification device comprising:
a layout pattern file for describing physical positions of a plurality of logic elements in a mask read only memory;
a ROM structure file for describing a layout condition of the logic elements in the mask read only memory;
ROM bit map file preparing means for specifying a plurality of placement areas of the logic elements according to the layout condition of the logic elements described in the ROM structure file and the physical positions of the logic elements described in the layout pattern file and preparing a ROM bit-map file indicating the placement areas of the logic elements;
a program code file for describing a plurality of program codes respectively indicating whether or not one logic element is placed at the corresponding placement area of the mask read only memory;
verifying ROM bit map file preparing means for specifying a plurality of placement areas of the logic elements of the mask read only memory corresponding to the program codes described in the program code file according to the layout condition of the logic elements described in the ROM structure file and preparing a verifying bit map file indicating the placement areas of the logic elements from the specified placement areas of the logic elements; and
verifying means for comparing the ROM bit map file prepared by the ROM bit map file preparing means and the verifying bit map file prepared by the verifying bit map file preparing means and verifying the physical positions of the logic elements described in the layout pattern file according to an obtained comparison result.
